(19) United States
(12) Patent Application Publication
(10) Pub. No.: US 2021/0303148 A1
(43) Pub. Date: Sep. 30, 2021

(54) Operation Reception Device and Operation Reception Method

(71) Applicant: Yamaha Corporation, Hamamatsu-shi (JP)

(72) Inventor: Kosuke SAITO, Hamamatsu-shi (JP)

(21) Appl. No.: 17/211,458

(22) Filed: Mar. 24, 2021

(30) Foreign Application Priority Data
Mar. 25, 2020 (JP) 2020-054747

(51) Int. Cl. G06F 3/0488; G06F 3/041; G06F 3/0484; G06F 3/0481

(52) U.S. Cl. CPC G06F 3/04886; G06F 3/04817; G06F 3/04842; G06F 3/041

(57) ABSTRACT

An operation reception device includes a touch panel, a detector, and a processor. The touch panel includes a first region and a second region that is different from the first region. The detector detects a first operation to the first region, and a second operation to the second region. The processor, when the detector detects the first operation, determines a presence or absence of the second operation and is brought into a selection state in which the processor selects processing to execute. The processor, when the detector detects the second operation while detecting the first operation, outputs a command to execute the processing.

### CROSS REFERENCE TO RELATED APPLICATIONS

This Nonprovisional application claims priority under 35 U.S.C. § 119(a) on Patent Application No. 2020-054747 filed in Japan on Mar. 25, 2020 the entire contents of which are hereby incorporated by reference.

### BACKGROUND

### Technical Field

An embodiment of the present disclosure relates to an operation reception device and an operation reception method that receive an operation of a user.

### Background Information

Digital mixers have a physical button and is turned ON when the physical ON button is pressed, a mixing console, and a program.

The digital mixers, in an operation of a user, are able to provide the user with an intuitive sense of operation of putting a finger on the physical button and pressing the physical button according to a timing. However, a touch panel displaying a virtual button determines that the virtual button has been pressed at a time when a touch operation is received. Therefore, the user cannot perform the operation of putting a finger on the button and pressing the button according to a timing. Accordingly, the user feels unnaturalness in the operation.

### SUMMARY

In view of the foregoing, an embodiment according to the present disclosure is directed to provide an operation reception device that includes a touch panel that is able to be naturally operated by a user and does not give the user a sense of unnaturalness, and an operation reception method.

An operation reception device includes a touch panel that includes a first region and a second region that is different from the first region, a detector that detects a first operation to the first region, and a second operation to the second region, and a processor that, when the detector detects the first operation, determines presence or absence of the second operation and is brought into a selection state in which the processor selects processing to execute, and, when the detector detects the second operation while detecting the first operation, outputs a command to execute the processing.

An operation reception device of an embodiment according to the present disclosure is able to provide a natural sense of operation that does not give a user a sense of unnaturalness. Other objects, advantages and novel features of the embodiments according to the present disclosure will become apparent from the following detailed description of one or more preferred embodiments when considered in conjunction with the accompanying drawings, in which:

### BRIEF DESCRIPTION OF THE DRAWINGS

FIG. 1 is a block diagram showing an example of a main configuration of a mixer 1;

FIG. 2 is a diagram showing an example of an operation reception region of a touch panel;

FIG. 3 is a flow chart showing an example of an operation of an operation reception device;

FIG. 4 is a diagram of a first modification of the operation reception region of a touch panel;

FIG. 5 is a diagram of a second modification of the operation reception region of a touch panel;

FIG. 6 is a diagram of a second modification of the operation reception region of a touch panel, the diagram showing an example different from the example shown in FIG. 5;

FIG. 7 is a diagram of a third modification of the operation reception region of a touch panel;

FIG. 8 is a diagram of a third modification of the operation reception region of a touch panel, the diagram showing an example different from the example shown in FIG. 7;

FIG. 9 is a flow chart showing a first modification of an operation of the operation reception device; and

FIG. 10 is a flow chart showing a second modification of an operation of the operation reception device.

### DETAILED DESCRIPTION

An operation reception device according to an embodiment of the present disclosure includes a touch panel, a detector, a processor, and a display. The touch panel receives a first operation from a user. The detector detects a first operation to the touch panel. The processor, when the detector detects the first operation, is brought into a selection state in which the processor selects processing to execute. In addition, the processor issues a command to detect a second operation, to the detector. Further, the processor, when the detector receives the second operation, outputs a command to execute processing. It is to be noted that the touch panel may be stacked on the display.

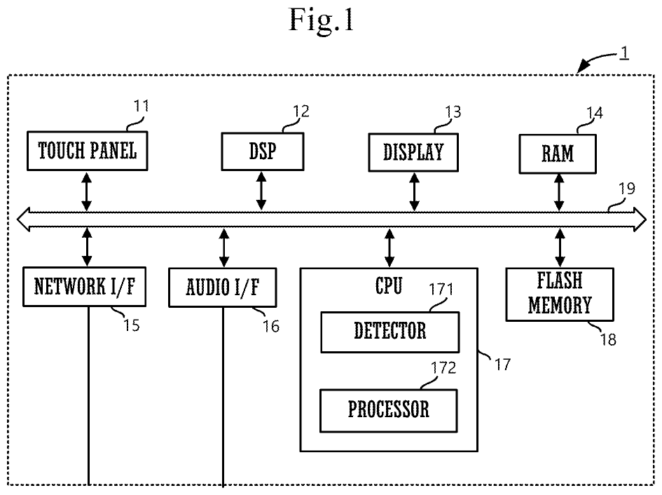

Hereinafter, a mixer 1 according to the embodiment will be described in more detail. FIG. 1 is a diagram showing an example of a configuration of the mixer 1. The mixer 1 includes a touch panel 11, a DSP 12, a display 13, a RAM 14, a network I/F 15, an audio I/F 16, a CPU 17, and a flash memory 18. In addition, the CPU 17 functionally includes a detector 171 and a processor 172. The mixer 1 is an example of the operation reception device.

The touch panel 11, the DSP 12, the display 13, the RAM 14, the network I/F 15, the audio I/F 16, the CPU 17, and the flash memory 18 are connected to each other through a bus 19.

The touch panel 11 receives various types of operations from a user. The various types of operations from a user include a touch operation on a panel or a long press operation on a panel, for example.

The network I/F 15 communicates with an external device of the mixer 1 through a network.

The audio I/F 16 sends and receives an audio signal to and from the external device of the mixer 1 through a signal line.

The DSP 12 performs signal processing on the audio signal to be received through the bus 19. The signal processing includes acoustic processing such as mixing processing or effect processing, for example. The audio signal on which the signal processing has been performed is outputted to the audio I/F 16 through the bus 19. It is to be noted that the DSP 12 may be constituted by a plurality of DSPs.

The flash memory 18 stores various programs. The various programs include a program to implement the function of the detector 171 and the processor 172, for example.

The RAM 14 temporarily stores a predetermined program stored in the flash memory 18.

The CPU 17 controls the operation of the mixer 1. The CPU 17 reads out the predetermined program stored in the flash memory 18 to the RAM 14 and performs various types of operations. It is to be noted that the program does not need to be stored in the flash memory 18 in the own device. For example, the CPU 17 may download the program each time from an external device through the network I/F 15 and may read out the program to the RAM 14.

The detector 171 detects the first operation and the second operation from a user, to the touch panel 11. The first operation is, for example, a long press operation on the touch panel 11. The second operation is, for example, a touch operation on the touch panel 11. The long press operation is, for example, an operation such that a user touches the touch panel 11 for a predetermined first time period (two seconds, for example) or longer, the predetermined first time being previously stored in the flash memory 18.

When the detector 171 detects the first operation from a user, the processor 172 selects processing to execute. A selection of the processing to be executed in the processor 172 is maintained until the detector 171 detects the second operation from a user (hereinafter referred to as a selection state). The processing to be executed may be processing to turn on or off a specific channel, processing to turn on or off a specific effect, processing to turn on or off a CUE (feed to a bus for a monitor) of a specific channel, scene recall, for example, or may be a function related to acoustic processing such as reproduction start. The scene recall includes a function to read various settings from the flash memory 18, the various settings including a parameter of various types of signal processing and patching of an input/output port and being stored in the flash memory 18. The processor 172 issues a command to detect the second operation, to the detector 171. When the detector 171 further receives the second operation, the processor 172 outputs a command to execute corresponding processing, to the DSP 12. In other words, the acoustic processing is executed in a case in which the user presses and holds the first region as the first operation, and in a case in which the touch operation on the second region is received as the second operation.

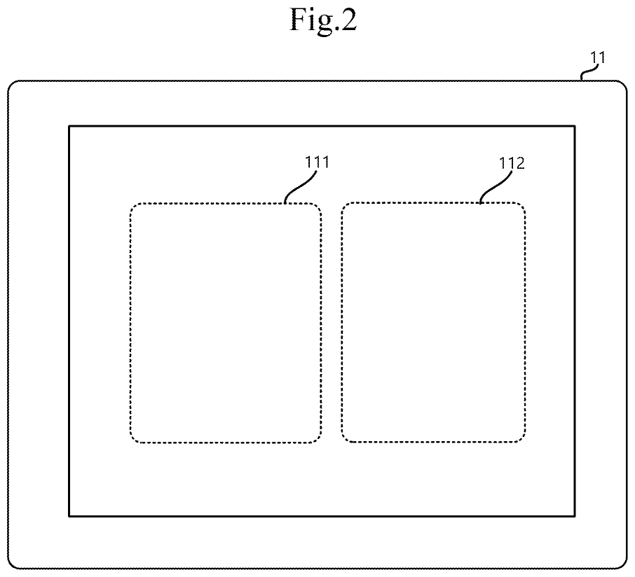

Subsequently, an operation reception region of the touch panel 11 will be described with reference to FIG. 2. FIG. 2 is a diagram showing an example of the operation reception region of the touch panel 11.

In the example of FIG. 2, the touch panel 11 is placed in a landscape orientation to a user. The touch panel 11 (the touch panel 11 on which the display 13 is stacked layer) includes a first region 111 and a second region 112. The entire region of the first region 111 is placed on the left side of the vertical center line of the touch panel 11. The entire region of the second region 112 is placed on the right side of the vertical center line of the touch panel 11. The first region 111 and the second region 112 have the same length of the width. In addition, the first region 111 and the second region 112 have the same height. When the user presses and holds the first region 111 (the left side), the first operation is detected. Then, in the second region 112 (the right side), the detection of the touch operation of the second operation from the user is enabled. At such a time, the second region is displayed on the touch panel 11. In such a state, a function of the acoustic processing assigned to the first region 111 is selected. For example, the function of the ON switch of an equalizer is selected. When the user performs the touch operation on the second region 112 (the right side), an assigned function is performed. In other words, when the user performs the long press operation on the first region 111 (the left side), the equalizer is selected. Then, when the user touches the second region 112 (the right side), the equalizer is turned ON. It is to be noted that, in a case in which the user stops the long press operation on the first region 111 before performing the touch operation on the second region 112 (the right side), the detection of the touch operation on the second region 112 by the detector 171 ends. Accordingly, only while the long press operation on the first region 111 continues, the touch operation on the second region 112 is enabled. Therefore, the equalizer is not turned ON when the user just touches the first region 111.

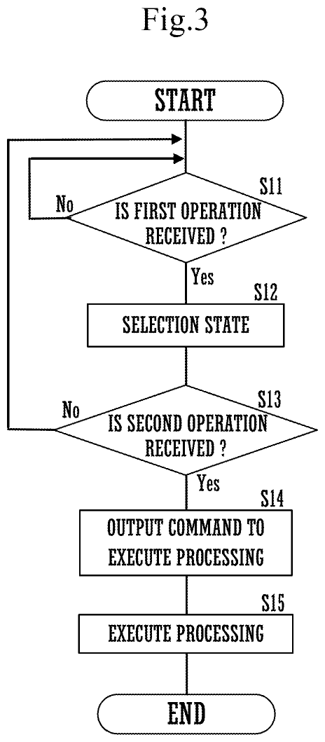

Subsequently, an operation from a user to the touch panel 11 and an operation of the mixer 1 will be described with reference to FIG. 3. FIG. 3 is a flow chart showing an example of the operation of the mixer 1.

The detector 171 detects whether or not the user has performed the first operation to the first region 111 (S11). The processor 172, when the detector 171 detects the first operation (S11: Yes), is brought into a selection state in which the processor 172 selects processing to execute (S12). For example, the processor 172 selects an equalizer. The detector 171, when the processor 172 is brought into the selection state (S12), detects whether or not the user has performed the second operation (S13). The processor 172, when the detector 171 detects the second operation (S12: Yes), outputs a command to execute the processing in the selection state, to the DSP 12 (S14). For example, the processor 172 outputs a command to cause the DSP 12 to execute signal processing corresponding to the selected equalizer. At such a time, the processor 172, when the detector 171 does not detect the second operation (S13: No), does not execute the processing of S14. Then, a processor such as the DSP 12 that has received an output from the processor 172 executes the processing (S15).

As described above, the user, as the first operation, by performing the touch operation on the second region (the right side) with a middle finger while performing the long press operation on the first region 111 (the left side) of the touch panel 11 with an index finger, for example, can determine the execution of the acoustic processing. In other words, the user first selects acoustic processing such as an equalizer by performing a long press operation with the index finger. Then, the user can determine the ON operation of the equalizer by performing the touch operation with the middle finger after having selected the acoustic processing. Therefore, the user, while estimating timing to execute the selected acoustic processing, can determine the execution of the acoustic processing by the operation of “pressing.” As a result, the user can perform an operation with a natural sense of operation similar to the operation of a physical switch.

It is to be noted that the operation of the mixer 1 shown in FIG. 3 is an example, and is not limited to the example.

### [First Modification of Operation Reception Region of Touch Panel 11]

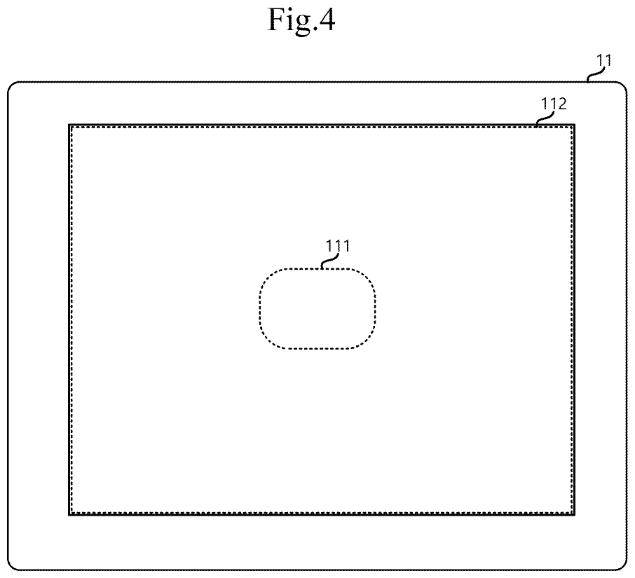

A first modification of an operation reception region of the touch panel 11 will be described with reference to FIG. 4. FIG. 4 is a diagram showing a modification of the operation reception region of the touch panel 11. It is to be noted that the same reference sign is given to the same configuration as the configuration in FIG. 2, and the description will be omitted.

In FIG. 2, the first region 111 and the second region 112 each are placed on the right and left of the center line of the touch panel 11. However, the first region 111 and the second region 112 may be placed anywhere as long as being within the touch panel 11.

For example, in FIG. 4, the first region 111 is placed near the center of the touch panel 11. The entire region other than the first region 111 in the touch panel 11 is the second region 112. In such a case, a user, as the first operation, by performing the touch operation on the second region (the entire region other than the first region 111) with a plurality of fingers (a thumb or a little finger, for example) while performing the long press operation on the first region 111 (the center) of the touch panel 11 with a middle finger, for example, can determine the execution of acoustic processing.

In other words, the user, while pressing and holing the first region 111 with the middle finger, can perform the touch operation on the second region 112 with a finger that the user thinks is the easiest to use for pressing, other than the middle finger. Further, the user, while pressing and holding the first region 111 with the middle finger, can also alternately press the second region 112 with a plurality of fingers that the user thinks are easy to use for pressing, other than the middle finger. Therefore, the user, while estimating timing to execute the selected acoustic processing, can determine the execution of the acoustic processing by the operation of “pressing with a finger that is easy to use for pressing.” In short, the first modification is able to provide a highly operable mixer 1 by which a user can execute acoustic processing with a finger that is easy to use for operation. However, in the present disclosure, it is unnecessary to place the first region 111 near the center and to place the second region 112 in the entire region other than the first region 111 in the touch panel 11.

[Second Modification of Operation Reception Region of Touch Panel 11]

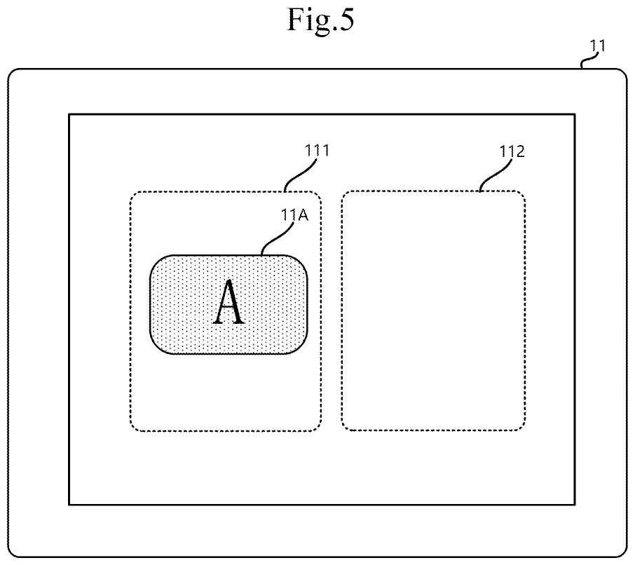

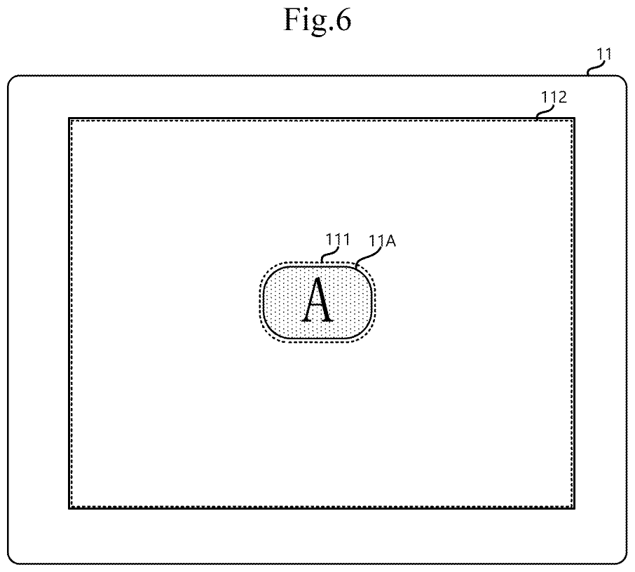

A second modification of an operation reception region of the touch panel 11 will be described with reference to FIG. 5 and FIG. 6. FIG. 5 and FIG. 6 are diagrams showing a modification of the operation reception region of the touch panel 11. It is to be noted that the same reference sign is given to the same configuration as the configuration in FIG. 2, and the description will be omitted.

In the display 13, a first operation button 11A that a user can visually see may be displayed to overlap the first region 111 or the second region 112.

The placement mode of the first region 111 and the second region 112 is the same as the example of FIG. 2. The entire region of the first operation button 11A is placed and displayed so as to be included in the first region 111. As a result, when a user performs a long press operation on the first operation button 11A, the user thus performs a long press operation on the first region 111 placed so as to include the first operation button 11A. In other words, the user, by pressing and holding the first operation button 11A that the user can visually see, can perform the first operation.

As described above, in the second modification, the first operation button 11A is placed and displayed so as to be included in the first region 111, so that the user can recognize where in the touch panel 11 the first region 111 is present. As a result, a possibility of an incorrect operation, for example, such that a user presses the first region 111 by mistake when the user desires to press the second region 112, is reduced. In other words, the second modification is able to provide a highly operable mixer 1 that makes it possible for a user to easily recognize the first region 111 and the second region 112.

However, in the second modification, the placement mode of the first region 111 and the second region 112 does not need to be the same as the example of FIG. 2. For example, as shown in FIG. 6, the placement mode of the first region 111 and the second region 112 may be made the same as the example of FIG. 4, and the first operation button 11A may be placed so as to be included in the first region 111.

[Third Modification of Operation Reception Region of Touch Panel 11]

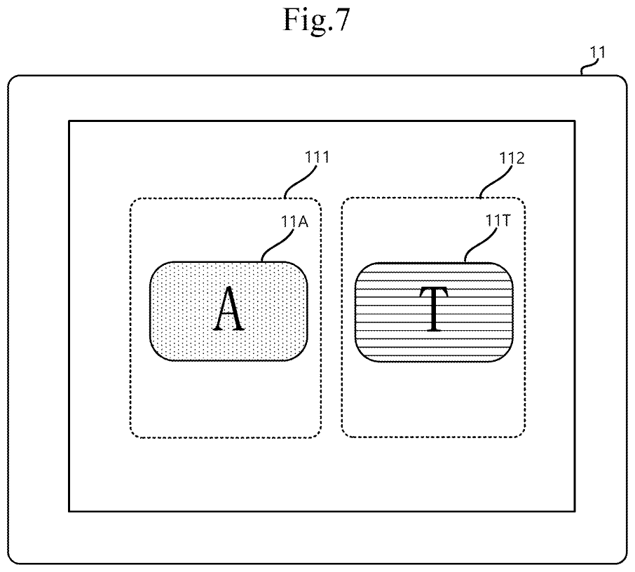

A third modification of an operation reception region of the touch panel 11 will be described with reference to FIG. 7. FIG. 7 is a diagram showing a modification of the operation reception region of the touch panel 11. It is to be noted that the same reference sign is given to the same configuration as the configuration in FIG. 5, and the description will be omitted.

The number of operation buttons to be displayed on the display 13 does not have to be one. The display 13, in addition to the first operation button 11A, may place and display a second operation button 11T that a user can visually see so as to be overlapped with the second region 112.

The placement mode of the first region 111, the second region 112, and the first operation button 11A is the same as the placement mode shown in FIG. 5. The entire region of the second operation button 11T is placed and displayed so as to be included in the second region 112. When a user performs a long press operation on the first region 111, the second operation button 11T is displayed. The second operation button 11T is not displayed until the long press operation is detected in the first region 111. Afterward, when the user performs the touch operation on the second operation button 11T, the user thus performs the touch operation on the second region 112 placed so as to include the second operation button 11T. In other words, the user can determine the execution of the acoustic processing by pressing and holding the first operation button 11A that the user can visually see and performing the touch operation on the second operation button 11T that the user can visually see.

As described above, in the third modification, the first operation button 11A to be included in the first region 111 and the second operation button 11T to be included in the second region 112 are placed and displayed. In such a case, the user can recognize where in the touch panel the first region 111 or the second region 112 is present. As a result, a possibility of an incorrect operation, for example, such that a user presses the first region 111 by mistake when the user desires to press the second region 112 by mistake, is reduced. In other words, the third modification is able to provide a highly operable mixer 1 that makes it possible for a user to more easily recognize the first region 111 and the second region 112. In addition, the second operation button 11T is displayed only after the long press operation on the first region 111 is detected. Further, in a case in which the long press operation on the first region 111 is stopped before the touch operation on the second region 112 (the right side) is detected, the display of the second operation button 11T may be turned off. Accordingly, the user can intuitively understand that the execution of acoustic processing cannot be determined until a long press operation is performed, and the execution of acoustic processing can be determined for the first time when another region is touched after the long press operation is performed. However, in the present disclosure, the second operation button 11T does not need to be displayed after the long press operation on the first region 111 is detected. The second operation button 11T may always be displayed.

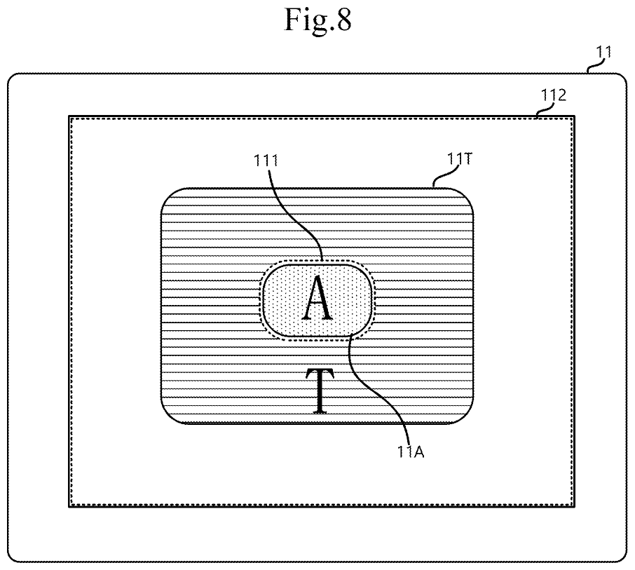

Moreover, in the third modification, the placement mode of the first region 111, the second region 112, the first operation button 11A, and the second operation button 11T is not limited to the example of FIG. 7. For example, as shown in FIG. 8, the placement mode of the first region 111, the second region 112, and the first operation button 11A may be made the same as the example of FIG. 6, and the second operation button 11T may be placed so as to include the first region 111 and the first operation button 11A.

[First Modification of Operation of Operation Reception Device]

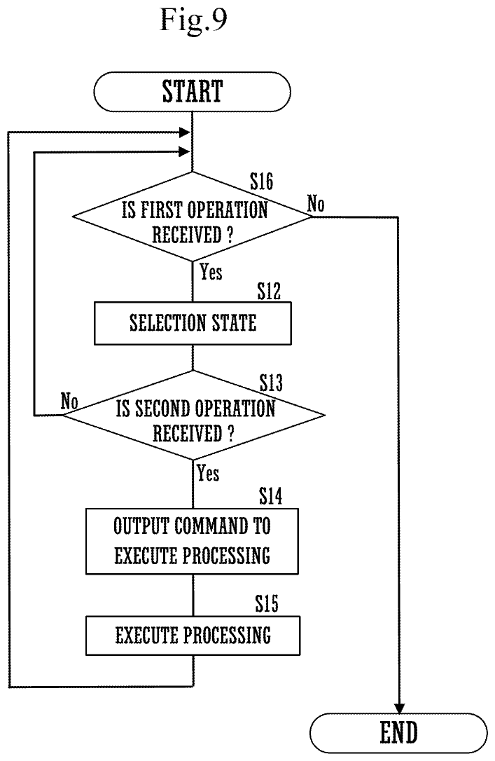

A first modification of an operation of an operation reception device will be described with reference to FIG. 9. FIG. 9 is a flow chart showing the first modification of the operation of the operation reception device. It is to be noted that the same reference sign is given to the same configuration as the configuration in FIG. 3, and the description will be omitted.

In the example of FIG. 9, a user, in a case of continuing the long press operation on the first region 111 as the first operation, can repeatedly determine the execution of the acoustic processing by repeatedly performing the touch operation on the second region 112.

The detector 171, while detecting the first operation, is able to repeatedly receive the second operation (S16: Yes, S12, S13, S14, S15). The detector 171 ends the processing (S16: No) when no longer detecting the first operation. Therefore, in a case in which the user performs the touch operation on the second region 112 as the second operation for a plurality of times when the user performs the long press operation on the first region 111 as the first operation, the acoustic processing is executed for the number of times of the touch operation on the second region 112.

As a result, the user can repeatedly determine the selected acoustic processing such as ON or OFF of such as an equalizer by repeatedly performing the touch operation on the second region 112 while continuing the long press operation on the first region 111. In other words, the user, while estimating timing to execute the selected acoustic processing, can determine the execution of the acoustic processing by the operation of “continuously pressing.” As a result, the user can perform an operation with a natural sense of operation similar to the operation of a physical switch.

[Second Modification of Operation of Operation Reception Device]

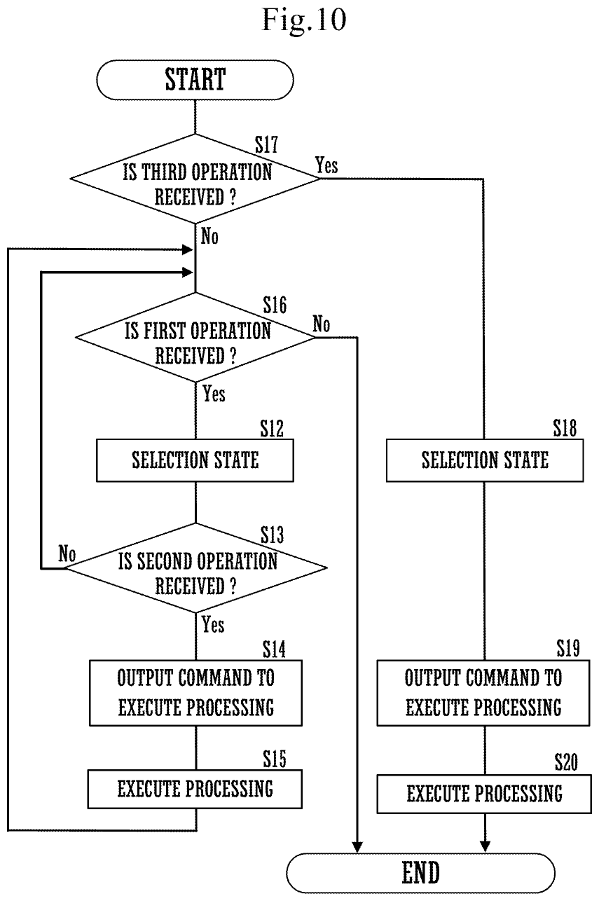

A second modification of an operation of an operation reception device will be described with reference to FIG. 10. FIG. 10 is a flow chart showing the second modification of the operation of the operation reception device. It is to be noted that the same reference sign is given to the same configuration as the configuration in FIG. 9, and the description will be omitted.

In a case in which the detector 171 detects the third operation of the user (S17: Yes), and even when the detector 171 does not detect the first operation and the second operation, the processor 172 is brought into the selection state of selecting processing (S18). The third operation, for example, is a tap operation on the first region 111 by the user within a predetermined second time period (one second, for example). Then, the processor 172 outputs a command to execute the processing in the selection state, to the DSP 12 (S19). The processor such as the DSP 12 that has received an output from the processor 172 executes the processing (S20). In other words, when the user quickly performs the touch operation on the first region 111 as the third operation, acoustic processing is executed regardless of whether the user has performed the first operation and the second operation. It is to be noted that, in a case in which the detector 171 does not detect the third operation of the user (S17: No), the operation reception device performs the same operation as the operation shown in FIG. 9 (S16, S12, S13, S14, S15).

As a result, the user can select the acoustic processing such as an equalizer by performing the long press operation on the first region 111. Then, the user can determine the ON operation of the equalizer by performing the touch operation on the second region 112 after having selected the acoustic processing. In addition, the user can immediately determine the ON or OFF operation of the equalizer by performing a tap operation on the first region 111 for a short time. In other words, the user can determine the execution of the acoustic processing by performing the operation of “pressing” while estimating timing to execute the acoustic processing that the user has selected, and can also immediately execute the acoustic processing. As a result, a more highly operable mixer 1 that enables a user to perform an operation suitable for a music scene that is being performed is able to be provided.

It is to be noted that the operation reception device is able to receive a touch operation on the touch panel 11 as the first operation and receive a press operation on the touch panel 11 as the second operation. In such a case, the second operation is detected by a pressure sensor or a capacitance sensor. For example, when a user presses (presses into the touch panel 11 with the finger that is performing the touch operation while continuing the touch operation being the first operation) into the touch panel 11 with the finger that has touched the touch panel 11, an area in which the finger touches the touch panel 11 is increased. Accordingly, the operation reception device is able to detect the press operation in a case in which the area to be detected by the capacitance sensor has increased.

The description of the present embodiments is illustrative in all points and should not be construed to limit the present disclosure. The scope of the present disclosure is defined not by the foregoing embodiments but by the scope of claims of patent. Further, the scope of the present disclosure is intended to include all modifications within the scopes of the claims of patent and within the meanings and scopes of equivalents.

What is claimed is:

1. An operation reception device comprising:
a touch panel that includes a first region and a second region that is different from the first region;
a detector that detects a first operation to the first region, and a second operation to the second region; and
a processor that
when the detector detects the first operation, determines a presence or absence of the second operation and is brought into a selection state in which the processor selects processing to execute, and
when the detector detects the second operation while detecting the first operation, outputs a command to execute the processing.

2. The operation reception device according to claim 1, further comprising: a display that displays the first region and the second region, wherein the second region is displayed on the display when the detector detects the first operation.

3. The operation reception device according to claim 2, wherein the display displays a first operation button to receive the first operation, in the first region.

4. The operation reception device according to claim 3, wherein the display displays a second operation button to receive the second operation, in the second region.

5. The operation reception device according to claim 3, wherein the display displays the second region around the first operation button or in a region other than the first region in the first operation button.

6. The operation reception device according to claim 1, wherein the second operation is a touch operation on the second region.

7. The operation reception device according to claim 1, wherein the detector detects the second operation after detecting the first operation.

8. The operation reception device according to claim 1, wherein the detector repeatedly receives the second operation while detecting the first operation.

9. The operation reception device according to claim 1, wherein the first operation is a long press operation on the first region for a first time period or longer.

10. The operation reception device according to claim 1, wherein
the detector detects a third operation to the first region;
the third operation is a touch operation on the first region, the touch operation being completed within a second time period; and
the processor outputs the command when the detector detects the third operation.

11. The operation reception device according to claim 1, wherein
the processing includes a plurality of functions according to acoustic processing; and
the acoustic processing includes at least one of ON of a CUE, ON of an effector, scene recall, and reproduction start.

12. An operation reception method comprising:
detecting a first operation to a first region of a touch panel, and a second operation to a second region of the touch panel, the second region being different from the first region;
determining a presence or absence of the second operation and bringing into a selection state of selecting processing to be executed, when detecting the first operation; and
outputting a command to execute the processing when detecting the second operation while detecting the first operation.

13. The operation reception method according to claim 12, further comprising: displaying the first region and the second region on a display, wherein the second region is displayed on the display when the first operation is detected.

14. The operation reception method according to claim 13, wherein the display displays a first operation button to receive the first operation, in the first region.

15. The operation reception method according to claim 14, wherein the display displays a second operation button to receive the second operation, in the second region.

16. The operation reception method according to claim 14, wherein the display displays the second region around the first operation button or in a region other than the first region in the first operation button.

17. The operation reception method according to claim 12, wherein the second operation is a touch operation on the second region.

18. The operation reception method according to claim 12, wherein the second operation is detected after the first operation is detected.

19. The operation reception method according to claim 12, wherein the second operation is repeatedly received while the first operation is detected.

20. The operation reception method according to claim 12, wherein the first operation is a long press operation on the first region for a first time period or longer.

21. The operation reception method according to claim 12, further comprising:
detecting a third operation to the first region, the third operation being a touch operation that is completed within a second time period, to the first region; and
bringing into the selection state and outputting the command when detecting the third operation.

22. The operation reception method according to claim 12, wherein
the processing includes a plurality of functions according to acoustic processing; and
the acoustic processing includes at least one of ON of a CUE, ON of an effector, scene recall, and reproduction start.
